(19) United States
(12) Patent Application Publication
(10) Pub. No.: US 2005/0190450 A1
(43) Pub. Date: Sep. 1, 2005

(54) Ultra high transmission phase shift mask blanks

(76) Inventors: Hans Becker, Meiningen (DE); Frank Schmidt, Jena (DE); Oliver Goetzberger, Meinigen (DE); Guenter Hess, Meinigen (DE); Ute Buttgereit, Zella-Mehlis (DE); Frank Sobel, La Baule-Escoublac (FR); Markus Renno, Meinigen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/040,115

(22) Filed: Jan. 24, 2005

Related U.S. Application Data
(60) Provisional application No. 60/608,515, filed on Sep. 10, 2004.

(30) Foreign Application Priority Data
Apr. 8, 2004 (EP) 04008566.4
Jan. 22, 2004 (EP) 04001359.1

(51) Int. Cl. G02B 27/00

(52) U.S. Cl. 359/601

(57) ABSTRACT

The present invention relates to phase shift mask blanks for exposure wavelength of less than 300 nm, a process for their preparation, to phase shift masks manufactured by such phase shift mask blanks and a process for the preparation of said phase shift masks.

This application claims the benefit of U.S. provisional patent application Ser. No. 60/608,515, filed Sep. 10, 2004.

The present invention relates to phase shift mask blanks for exposure wavelength of less than 300 nm, a process for their preparation, to phase shift masks manufactured by such phase shift mask blanks and a process for the preparation of said phase shift masks.

### BACKGROUND OF THE INVENTION

There is considerable interest in phase shift masks as a route to extending resolution, contrast and depth focus of lithographic tools beyond what is achievable with the normal binary mask technology (FIG. 2).

Among the several phase shifting schemes, the (embedded) attenuating phase shift masks (also referred to as half tone phase shift masks) proposed by Burn J. Lin, Solid State Technology, January issue, page 43 (1992), the teaching of which is incorporated herein by reference, is gaining wider acceptance because of its ease of fabrication and the associated cost savings (FIG. 4).

Besides the technical solution of the attenuating phase shift masks, alternating phase shift masks (also referred to as hard type or Levinson type phase shift masks) have also been proposed (FIG. 3). In such alternating phase shift masks, the substrate is provided with a slightly transparent layer, e.g. a very thin chrome layer, coupled with etching into the quartz substrate to produce the desired phase shift. This method requires a high degree of control of both layer deposition and etch process, since the phase shift of the resulting mask blank is determined by the depth of the etching into the quartz substrate.

### SUMMARY OF THE INVENTION

According to a first aspect, the present invention relates to a phase shift mask blank, the mask blank comprising a substrate and a phase shift system
wherein said phase shift system comprises at least two layers;
wherein at least one of the layers of the phase shift system is a phase shift layer and provides a phase shift function and wherein at least one further layer of the phase shift system is an etch stop layer and provides an etch stop function;
said mask blank being able of producing a photomask with substantially 180° phase shift and an optical transmission of at least 40%, at an exposure light having a wavelength of 300 nm or less.

According to a second aspect, the present invention relates to a process for the preparation of a phase shift mask, the mask blank comprising a substrate and a phase shift system, wherein said phase shift system comprises at least two layers; wherein at least one of the layers of the phase shift system is a phase shift layer and provides a phase shift function and wherein at least one further layer of the phase shift system is an etch stop layer and provides an etch stop function; said mask blank being able of producing a photomask with substantially 180° phase shift and an optical transmission of at least 40 at an exposure light having a wavelength of 300 nm or less, comprising the steps
providing a substrate; and
providing a thin film system;
   wherein providing a thin film system comprises the steps of
forming at least one etch stop layer on the substrate,
forming at least one phase shift layer on an etch stop layer.

Preferably, for the deposition of the layer system a method selected from the group consisting of dual ion beam deposition,

A third aspect of the present invention relates to a phase shift photomask for lithography, the photomask comprising a substrate and a phase shift system, wherein said phase shift system comprises at least two layers, wherein at least one of the layers of the phase shift system is a phase shift layer and provides a phase shift function and wherein at least one further layer of the phase shift system is an etch stop layer and provides an etch stop function, said photomask having substantially 180° phase shift and an optical transmission of at least 40%, at an exposure light having a wavelength of 300 nm or less.

A forth aspect of the present invention relates to a method of manufacturing a photomask for lithography, the photomask comprising a substrate and a phase shift system, wherein said phase shift system comprises at least two layers, wherein at least one of the layers of the phase shift system is a phase shift layer and provides a phase shift function and wherein at least one further layer of the phase shift system is an etch stop layer and provides an etch stop function, said photomask having substantially 180° phase shift and an optical transmission of at least 40% at an exposure light having a wavelength of 300 nm or less; comprising the steps of
providing a mask blank comprising a substrate, a phase shift system and a light shielding layer, wherein said phase shift system comprises at least two layers; wherein at least one of the layers of the phase shift system is a phase shift layer and provides a phase shift function and wherein at least one further layer of the phase shift system is an etch stop layer and provides an etch stop function;
etching the light shielding layer using a first etching agent;
etching the layer on the substrate using a second etching agent; wherein said second etching agent substantially does not etch the substrate.

These and other aspects and objects, features and advantages of the present invention will become apparent upon a consideration of the following detailed description and the invention when read in conjunction with the drawing Figures.

It is to be understood that both the forgoing general description and the following detailed description are merely exemplary of the invention, and are intended to provide an overview or framework for understanding the nature and character of the invention as claimed.

### BRIEF DESCRIPTION OF THE DRAWINGS

In the Figures:

FIG. 1 shows a schematic cross sections of mask blanks (FIG. 1a, FIG. 1e) and photomasks (FIG. 1c, FIG. 1d, FIG. 1g or FIG. 1h) according to embodiments of the present invention.

FIGS. 2 to 4 show photomasks according to the state of the art, i.e. a binary (FIG. 2), alternating phase shift (FIG. 3) and attenuated phase shift (FIG. 4) photomask.

FIG. 5 shows dispersion curves of SiO₂, Ta₂O₅, Cr₂O₃ and a quartz substrate.

FIG. 6 shows the tuneability of a phase shift system according to one embodiment of the present invention.

FIG. 7 shows the tuneability of a phase shift system according to a further embodiment of the present invention.

FIGS. 8a and 8b show the optical performance of a mask blank according to an Example.

FIG. 9 shows a laser durability test of a mask blank according to an Example.

FIG. 10 shows an apparatus for depositing one or more layers of the phase shift mask blank according to an embodiment of the second aspect of the present invention.

### DETAILED DESCRIPTION OF THE PREFERRED EMBODIMENTS

As known in the art, a “photomask blank” or “mask blank” differs from a “photomask” or “mask” in that the latter term is used to describe a photomask blank after it has been structured or patterned or imaged. While every attempt has been made to follow this convention herein, those skilled in the art will appreciate the distinction in not a material aspect of this invention. Accordingly, it is to be understood that the term “photomask blank” or “mask blank” is used herein in the broadest sense to include both imaged and non-imaged photomask blanks.

According to the present invention, the expressions “under” and “on” when used to describe the relative position of a first layer to a second layer in the layer system of the mask blank have the following meaning: “under” means that said first layer is provided closer to the substrate of the mask blank than said second layer and the expression “on” means that said first layer is provided further remote from the substrate than said second layer.

Furthermore, if not explicitly mentioned otherwise, the expressions “under” or “on” can mean “directly under” as well as “under, but at least one further layer is provided in between said two layers” or “directly on” as well as “on, but at least one further layer is provided between said two layers”.

The expression “having a phase shift of substantially 180°” means that the phase shift mask blank provides a phase shift of the incident light sufficient to cancel out light in the boundary section of a structure and thus to increase the contrast at the boundary. According to certain embodiments of the present invention, a phase shift of 160° to 190°, preferably of 170° to 185° is provided.

The phase shift system of the mask blank of the present invention has a transmission of at least about 40%, preferably of at least about 50%, more preferably at of least about 60%, at an exposure light having a wavelength of less than 300 nm. According to certain embodiments of the present invention, the phase shift system of the mask blank of the present invention has a transmission of at least about 80%. According to the present invention, the expression “the transmission of the phase shift mask blank” or the like expressions are used as an abbreviation of the expression “the transmission of the phase shift system of the phase shift mask blank”. Since the transmission of the substrate is selected to be as high as possible, such as e.g. substantially higher than 90%, the contribution of the substrate to the overall transmission of the mask blank can be considered as minor.

The present inventors have found that the new type of phase shift mask blanks according to the present invention combines the advantages of alternating and attenuated phase shift mask blanks and simultaneously avoids drawbacks of the state of the art systems. In particular, since an etch stop between the phase shift layer and the substrate is provided, overetching into the substrate is avoided and a uniform phase shift of e.g. 180° (or any other value as desired) can be provided across the whole surface of the phase shift mask blank. Furthermore, compared to an attenuating phase shift mask blanks, even light with a low intensity is avoided and the resolution of the mask blank is excellent.

According to a first aspect, the present invention relates to a phase shift mask blank, the mask blank comprising a substrate and a phase shift system
wherein said phase shift system comprises at least two layers;
wherein at least one of the layers of the phase shift system is a phase shift layer and provides a phase shift function and wherein at least one further layer of the phase shift system is an etch stop layer and provides an etch stop function;
said mask blank being able of producing a photomask with substantially 180° phase shift and an optical transmission of at least 40%, at an exposure light having a wavelength of 300 nm or less.

According to the present invention, an etch stop layer may provide an etch stop function relative to the layer on the etch stop layer, i.e. when the layer on the etch stop layer is etched by an etching agent, said etching agent will substantially not etch the etch stop layer or said etching agent will etch the etch stop layer substantially slower than the layer on the etch stop layer.

Alternatively, an etch stop layer may provide an etch stop function relative to the layer under the etch stop layer, i.e. when the etch stop layer itself is etched by an etching agent, said etching agent will substantially not etch the layer under the etch stop layer or said etching agent will etch the layer under the etch stop layer substantially slower than the etch stop layer. In this context, the substrate of the mask blank is also considered as a layer under an etch stop layer.

In a phase shift mask blank, an etch stop function should at least be present between the light shielding layer and the phase shift layer, and between the phase shift layer and the substrate.

In case a functional layer, such as e.g. a phase shift layer provides an etch stop function itself, an additional etch stop layer may not be necessary on said functional layer. However, if such a functional layer does not sufficiently provide an etch stop function, an etch stop layer may be provided between the functional layer and the layer to which an etch stop function is necessary. E.g. an etch stop layer may be provided in particular on and/or under the phase shift system.

An etch stop layer providing an etch stop function has preferably a thickness of at least 0.5 nm. According to certain embodiments, the etch stop layer has a thickness of at least 8 nm or even at least 10 nm.

The minimum thickness of the etch stop layer depends on the etch stop function of the etch stop layer. If the etch stop layer is substantially not etched by the etching agent used for etching the layer on top of the etch stop, a thin layer of e.g. 0.5, 0.8 or 1 nm may impart sufficient etch stop function to the etch stop layer.

The maximum thickness of the etch stop layer is not limited. However, in case the extinction coefficient k of the material forming the etch stop layer is 0.5 or more, or even 1.0 or more, the etch stop layer should be as thin as possible in order not to impair the transmission of the phase shift mask blank. E.g., in such a case the etch stop layer preferably has a thickness of at most 20 nm, preferably at most 16 nm.

According to one embodiment, an etch stop layer essentially consists of one or more materials having a value for the extinction coefficient k of about 1.5 or less, more preferably of about 1.2 or less at exposure light wavelength.

According to a further embodiment, an etch stop layer essentially consists of one or more materials having a value for the extinction coefficient k of about 0.3 or less, more preferably of about 0.05 or less at exposure light wavelength.

An etch stop layer of the mask blank of the present invention preferably comprises a material selected from the group consisting of oxides or fluorides of Si, Ge, Sn, B, Al, Ga, Ti, Zr, Hf, V, Nb, Ta, Cr, Mo, W, Y, La, Gd or mixtures thereof. The etch stop layer may further contain C, and/or N in an amount of up to 5 at.-%. According to one embodiment of the present invention, the material of the etch stop layer comprises oxides of Si, Ta, Ti, Cr, Hf, and/or Mo.

The material of the etch stop layer preferably is different from the material of the phase shift layer. It might contain different metals and/or semimetals such as Si, Ge, Sn, B, Al, Ga, Ti, Zr, Hf, V, Nb, Ta, Cr, Mo, W, Y, La, Gd in the phase shift layer; or it might contain the same metal and/or semimetals combined with different elements or mixtures of elements such as O, N, and C.

A phase shift layer preferably essentially consists of one or more materials having a value for the extinction coefficient k of about 0.3 or less, more preferably of about 0.05 or less at exposure light wavelength.

A phase shift layer of the mask blank of the present invention preferably comprises a material selected from the group consisting of oxides and/or nitrides of Si, Al, B or mixtures thereof. The phase shift layer may further contain C and/or other metals as mentioned above in an amount of up to 5 at.-%, according to certain embodiments only in an amount up to about 1%. Examples as materials for a phase shift layer of the present invention are SiO₂, Al₂O₃, Si₃N₄, SiON, B₂O₃, and mixtures thereof.

The phase shift system of the present invention may comprise one, two or even more phase shift layers in combination with one, two or more etch stop layers.

In case at least two phase shift layers or at least two etch stop layers are provided in the phase shift system of the present invention, phase shift layers and etch stop layers may be provided in an alternating sequence. However, it is also possible that the layers are provided in a non-alternating way, i.e. two or more phase shift layers are provided directly on a phase shift layer, or that two or more etch stop layers are provided directly on an etch stop layer. Mixtures of alternating systems and non-alternating systems are also possible.

According to one embodiment of the present invention, the upper layer of the phase shift system imparts a barrier or protection function to the phase shift system, i.e. prevents substantial degradation of the phase shift layer during processing and cleaning of the mask blank and photomask.

According to certain embodiments of the present invention, the mask blank additionally comprises a barrier layer providing a barrier function wherein said barrier layer is provided on the phase shift system, wherein said barrier layer has a thickness of at most 4 nm, preferably at most 2 nm, and/or a thickness of at lease 0.2 nm and/or wherein said barrier layer preferably comprises a metal oxide such as an oxide of Ti, Zr, Hf, V, Nb, Ta, Cr, Mo, W, Y, La, Gd or mixtures thereof.

According to certain embodiments of the present invention, the mask blank additionally comprises at least one antireflection layer providing an antireflection function, wherein an antireflection layer preferably is provided on, under and/or in the phase shift system, wherein said antireflection layer preferably has a refractive index at exposure wavelength which is lower than the refractive index of the layer on which the antireflection layer is provided.

According to certain embodiments of the present invention, the mask blank additionally comprises a light shielding or absorbing layer on the phase shift system, such as a chromium comprising layer or a TaN layer.

According to one embodiment of the present invention, one or more layers of the phase shift mask blank may have a gradual change of the composition in different distances from the substrate.

According to one embodiment of the present invention, the phase shift system has a thickness of at most 350 nm, preferably of at most 300 nm.

According to one embodiment of the present invention, the phase shift system of the phase shift mask blank comprises one phase shift layer and one etch stop layer provided under the phase shift layer. Further layers such as a barrier layer and/or one or more antireflection layer may also be provided. According to this embodiment the phase shift layer essentially consists of silicon, oxygen and/or nitrogen. Up to 5 at.-% of other metals an/or elements may be contained in said phase shift layer. The phase shift layer according to this embodiment preferably has a thickness of at least 50 nm and at most 300 nm.

According to a further embodiment of the present invention, the phase shift system of the phase shift mask blank comprises a layer comprising aluminum oxide and/or a layer comprising silicon oxide. Further layers such as a barrier layer and/or one or more antireflection layer may also be provided. According to this embodiment the phase shift layer essentially consists of aluminum, silicon, oxygen and/or nitrogen. Up to 5 at.-% of other metals and/or elements may be contained in said phase shift layer. The phase shift layer according to this embodiment preferably has a thickness of at least 50 nm and at most 300 nm.

The substrate material for the phase shift mask according to the present invention preferably is formed of high purity fused silica, fluorine doped fused silica (F—SiO₂), calcium fluoride, and the like.

The thin film system of mask blank may be free from defects having a particle size of 0.5 μm or more. Preferably, said thin film system has at most 50 defects, more preferably at most 20 defects, having a particle size of 0.3 μm to 0.5 μm. With decreasing feature sizes on a photomask, defects having a size of 500 nm or more will pose a problem and therefore must not be present. With respect to defects having a particle size of 0.3 to 0.5 μm, a limited amount of up to 50 defects per mask blank is tolerable for many applications. Furthermore, the mask blank may have a surface roughness (RMS) of at most 5 Å according to specific embodiments of the present invention. Using the assist source according to the present invention improves the surface roughness of particularly a SiO₂ layer. FIG. 12a to c shows the AFM measured surface roughness of a SiO₂ layer according to comparative examples (12a and 12b) without the use of the assist source and an inventive example (12c).

According to the second aspect of the invention, one, some or all of the layers and sublayers of the thin film system may have a mean uniformity of film thickness of at most 2%, preferably of at most 1%, more preferably of at most 0.5%. Providing a phase shift system having a highly uniform layer thickness results in a phase shift mask blank having a high uniformity in view of the phase shift and the transmission on all positions of the mask blank. In particular, the phase shift of said phase shift mask blank may have a deviation from the mean value of the phase shift of at most about ±2°, more preferably of at most ±1.5°, and the transmission of said phase shift mask blank may have a deviation from the mean transmission value of at most about ±0.5%.

According to a second aspect, the present invention relates to a process for the preparation of a phase shift mask, the mask blank comprising a substrate and a phase shift system, wherein said phase shift system comprises at least two layers; wherein at least one of the layers of the phase shift system is a phase shift layer and provides a phase shift function and wherein at least one further layer of the phase shift system under the phase shift layer is an etch stop layer and provides an etch stop function; said mask blank being able of producing a photomask with substantially 180° phase shift and an optical transmission of at least 40%, at an exposure light having a wavelength of 300 nm or less, comprising the steps
providing a substrate; and
providing a thin film system;
   wherein providing a thin film system comprises the steps of
forming at least one etch stop layer on the substrate,
forming at least one phase shift layer on an etch stop layer.

Preferably, the phase shift system and or one or more further layers of the thin film system are formed by sputter deposition using a technique selected from the group consisting of dual ion beam sputtering, ion beam assisted deposition, ion beam sputter deposition, RF matching network, DC magnetron, AC magnetron, and RF diode.

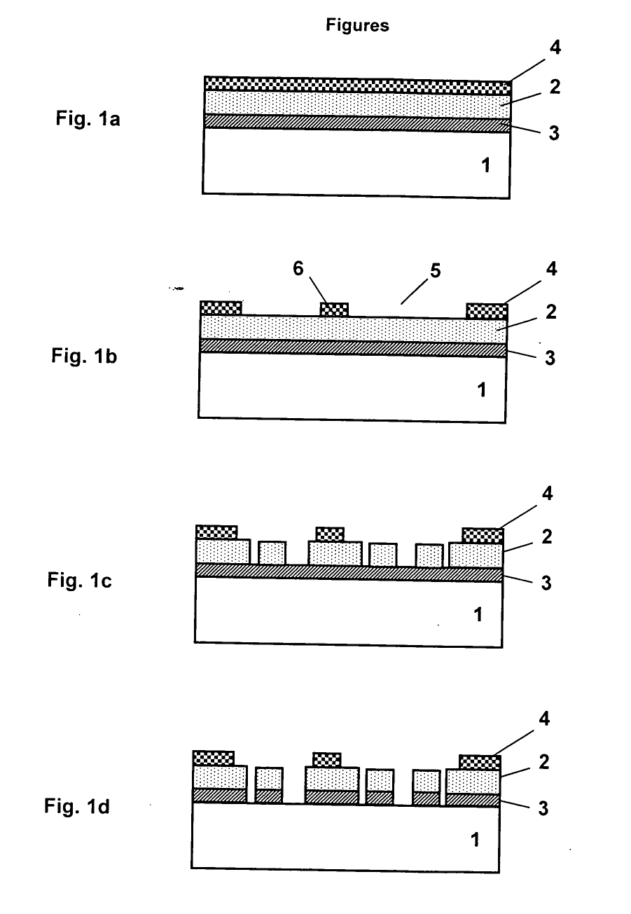

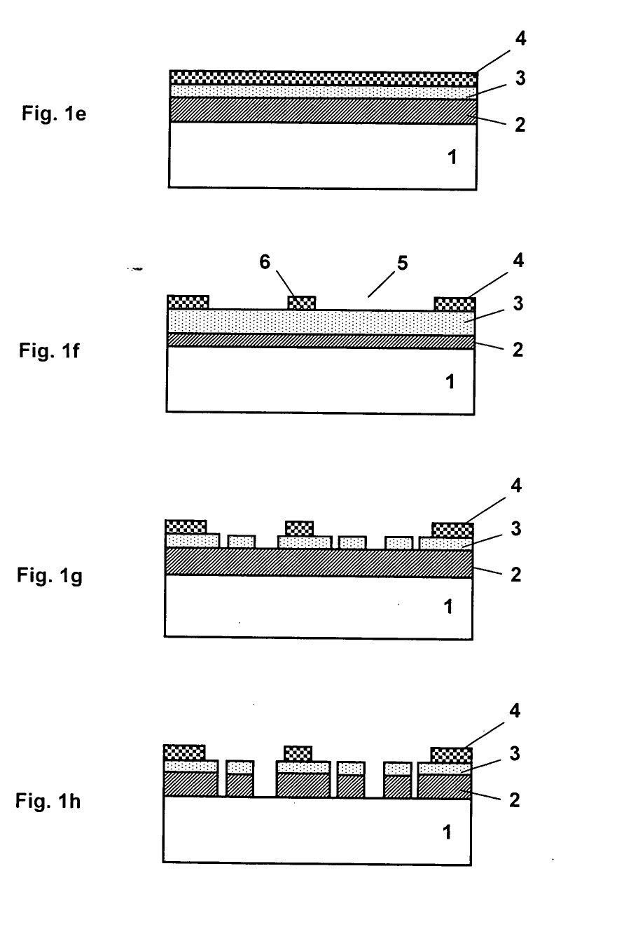

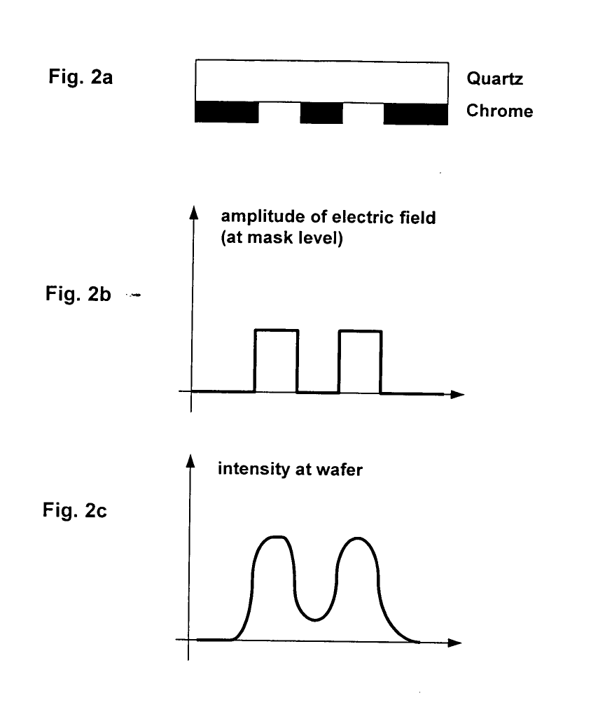

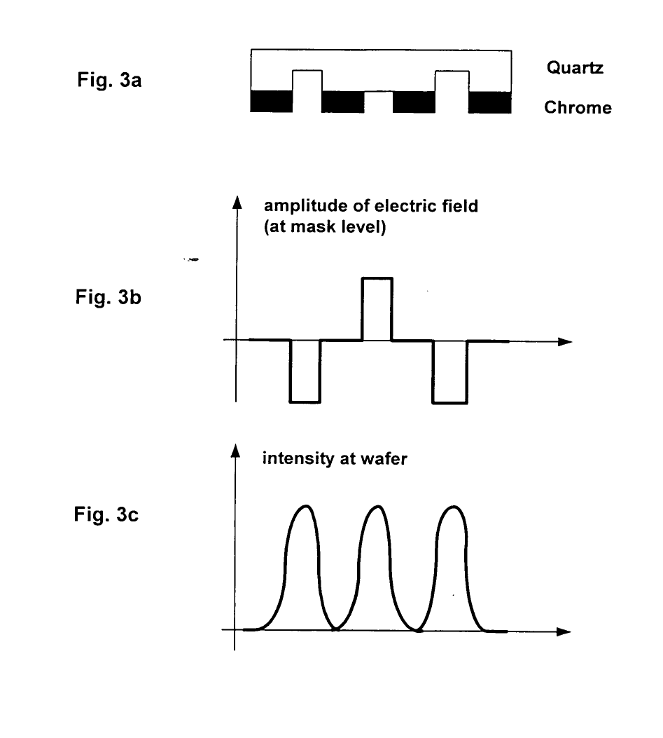

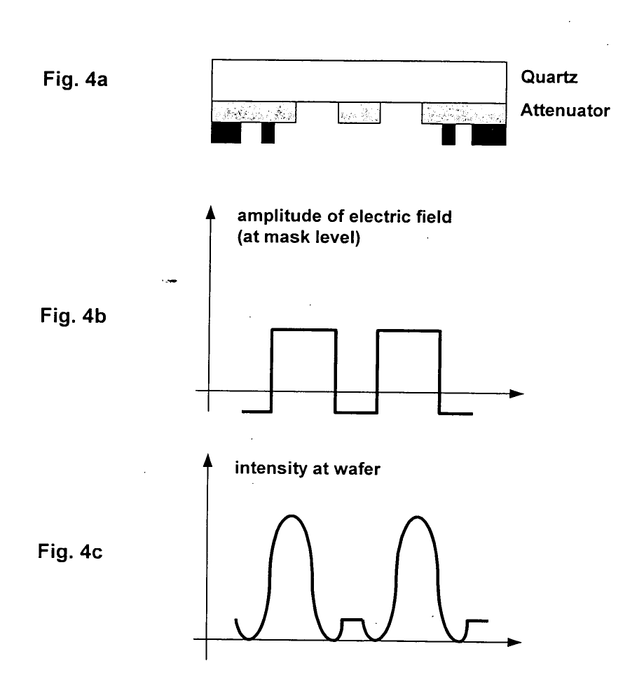

FIG. 1 schematically shows an exemplary setup of a deposition apparatus 10 for manufacturing of photo mask blanks by ion beam sputtering (IBS) or ion beam deposition (IBD) according to the present invention. The apparatus 10 comprises a vacuum chamber 12 which can be evacuated by a pump system.

A deposition particle source or more specifically ion deposition source 20 creates a first particle or ion beam 22. The deposition ion source 20 is a high frequency (HF) ion source, however, also other types of ion sources may be used. The sputter gas 24 is led into the deposition ion source 20 at inlet 26 and is ionized inside the deposition ion source 20 by atomic collisions with electrons that are accelerated by an inductively coupled electromagnetic field. A preferably curved three grid ion extraction assembly 28 is used to accelerate the primary ions, comprised in the first ion beam 22 and focus them towards the target 40.

The primary ions are extracted from the deposition ion source 20 and hit a target or sputter target 40, thereby causing cascades of atomic collisions and target atoms are bombed out. This process of sputtering or vaporizing the target is called the sputter process. The sputter target 40 is e.g. a target comprising or consisting of tantalum, titanium, silicon, chrome or any other metal or compound as mentioned below, depending on the layer to be deposited. The deposition apparatus may be equipped with a plurality of different sputter targets that differ in respect of the chemical composition in a way that the sputtering process can be changed to another target without the need to interrupt the vacuum. Preferably, the sputter process and the deposition of the layers take place in a suitable vacuum.

The momentum transfer to the target atoms is at largest, when the mass of the primary ions is equivalent to the mass of the target atoms. As noble gases are easy to handle, preferably helium, argon or xenon is used as the sputter gas 24. Xenon is preferred as a sputter gas since the use of Xenon during sputtering increases the uniformity of the thickness of the deposited layers.

At least a portion of the sputtered ions 42 emerges from the target 40 in direction to substrate 50. The sputtered ions 42 hit the substrate 50 with an energy which is much higher than with conventional vapor deposition, deposition or growing highly stable and dense layers or films on the substrate 50.

In particular, the mean energy of the sputtered atoms, e.g. metal atoms, is adjusted or controlled by the energy and/or the incident angle of the first ion beam 22. The incident angle of the first ion beam 22 with respect to the target normal line 44 is adjusted by pivoting the target 40.

The substrate 50 is rotatably mounted in a three-axis rotation device. The mean incident angle α of the sputtered ions with respect to normal line 54 of the substrate 50 is adjusted by pivoting the substrate 50 around a first axis. By adjusting the incident angle a uniformity, internal film structure and mechanical parameters, in particular film stress can be controlled and consequently improved.

Furthermore, the substrate 50 can be rotated perpendicular to the normal line 54 representing a second axis of rotation, to further improve the uniformity of the deposition.

The substrate is additionally rotatable or pivotable around a third axis, allowing it to move the substrate out of the beam to allow for example cleaning of the substrate 50 immediately before deposition.

Furthermore, the apparatus 10 comprises an assist particle source or assist ion source 60. The operation principle is the same as the deposition source 20. A second particle or ion beam 62 is directed towards the substrate 50, e.g. for flattening, conditioning, doping and/or further treatment of the substrate 50 and/or films deposited on the substrate 50. Further active and/or inactive gasses 64 may be introduced via gas inlet 66.

The second ion beam 62 is accelerated preferably by a straight three grid extraction system 68.

Preferably, assist source 60 is used to introduce active gasses such as oxygen and nitrogen to the system.

The second ion beam 62 substantially covers the whole substrate 50 to obtain a uniform ion distribution or treatment all over the substrate area. As can be seen in FIG. 1 the substrate 50 is tilted by an angle b with respect to the axis 65 of the second ion beam 62.

In the state of the art, the second ion beam 62 is particularly used to
dope the films with oxygen, nitrogen, carbon and/or other ions,
clean the substrate, for example with an oxygen plasma, before the deposition,
improve the interface quality of the films by flattening the films
to improve the uniformity of the thickness of a deposited layer.

According to an embodiment, the phase shift system and/or optional further layers are deposited in a single chamber of deposition apparatus without interrupting the ultra high vacuum. It is particularly preferred to deposit the phase shift system without interrupting the vacuum. Thus, decontamination of the mask blank with surface defects can be avoided and a phase shift mask blank substantially free of defects can be achieved. Such a sputtering technique can e.g. be realized by using a sputter tool that allows sputtering from several targets. Thus, high quality phase shift masks having a low defect density and/or highly uniform layers with respect to the thickness of the layers can be achieved.

As the sputtering targets, targets comprising elements or targets comprising components can be used. In case the deposited layer contains an oxide, nitride or oxy nitride of a metal or semimetal, it is possible to use such oxide, nitride or oxy nitride of a metal or semimetal as the target material. However, it is also possible to use a target of a metal or semimetal and to introduce oxygen and/or nitrogen as an active sputtering gas. In case of the deposition of SiO₂, it is preferred to use a target of Si and to introduce oxygen as an active gas. In case the deposited layer shall comprise nitrogen, it is preferred to introduce nitrogen as an active sputtering gas. In case an elemental metal or semimetal or a mixture thereof is to be sputtered, a target of such elemental metal or semimetal and to use a noble gas such as argon or xenon in the assist source.

For the sputtering gas, it is preferred to use inactive gasses such as helium, argon or xenon. Such inactive gasses can be combined with active gasses such as oxygen, nitrogen, nitrogen monoxide, nitrogen dioxide, and dinitrogen oxide or mixtures thereof. Active gasses are gasses that may react with sputtered ions and thus become part of the deposited layer. According to a preferred embodiment of the present invention, during the sputtering of the phase shift control layer, a mixture of an inactive gas and oxygen is used as an additional sputtering gas. In case a phase shift mask blank having a high uniformity of the thickness of the layers and thus the phase shift and/or the transmission is to be provided, it is preferred to use xenon as an inactive sputtering gas. Xe as the sputtering gas results in highly uniform sputtered layers.

A third aspect of the present invention relates to a phase shift photomask for lithography, the photomask comprising a substrate and a phase shift system, wherein said phase shift system comprises at least two layers, wherein at least one of the layers of the phase shift system is a phase shift layer and provides a phase shift function and wherein at least one further layer of the phase shift system under the phase shift layer is an etch stop layer and provides an etch stop function, said photomask having substantially 180° phase shift and an optical transmission of at least 40%, preferably of at least 50%, more preferably of at least 60%, at an exposure light having a wavelength of 300 nm or less.

A forth aspect of the present invention relates to a method of manufacturing a photomask for lithography, the photomask comprising a substrate and a phase shift system, wherein said phase shift system comprises at least two layers, wherein at least one of the layers of the phase shift system is a phase shift layer and provides a phase shift function and wherein at least one further layer of the phase shift system under the phase shift layer is an etch stop layer and provides an etch stop function, said photomask having substantially 180° phase shift and an optical transmission of at least 40%, at an exposure light having a wavelength of 300 nm or less; comprising the steps of
providing a mask blank comprising a substrate, a phase shift system and a light shielding layer, wherein said phase shift system comprises at least two layers; wherein at least one of the layers of the phase shift system is a phase shift layer and provides a phase shift function and wherein at least one further layer of the phase shift system is an etch stop layer and provides an etch stop function;
etching the light shielding layer using a first etching agent;
etching the layer on the substrate using a second etching agent; wherein said second etching agent substantially does not etch the substrate.

As an etching process, a dry etching method using a chlorine-based gas such as Cl₂, Cl₂+O₂, CCl₄, CH₂Cl₂, or a wet etching using acid, alkali or the like may be used. However, a dry etching method is preferred. Also possible are etching methods using a fluorine containing component, reactive ion etching (RIE) using fluorine gasses such as CHF₃, CF₄, SF₆, C₂F₆ and mixtures thereof is preferred. In general, at least two different etching methods and/or agents are employed when etching the mask blanks of the present invention.

The entire disclosures of all applications, patents and publications, cited above and below, and of corresponding European Application No. 04 001359.1, filed Jan. 22, 2004, and U.S. provisional application Ser. No. 60/608,515, filed Sep. 10, 2004, are hereby incorporated by reference.

### EXAMPLES

In the following, the design and fabrication of mask blanks according to a preferred embodiment of the present invention are described.

Exemplary Film Design and Transmission Tuning

The n and k values were obtained at 157, 193 and 248 nm from the ellipsometer measurement using a model Woollam VASE Spectroscopic Ellipsometer. Typically, the spectroscopic scan was taken at 55 and 65 degrees. Transmission data was taken to improve the model fitting.

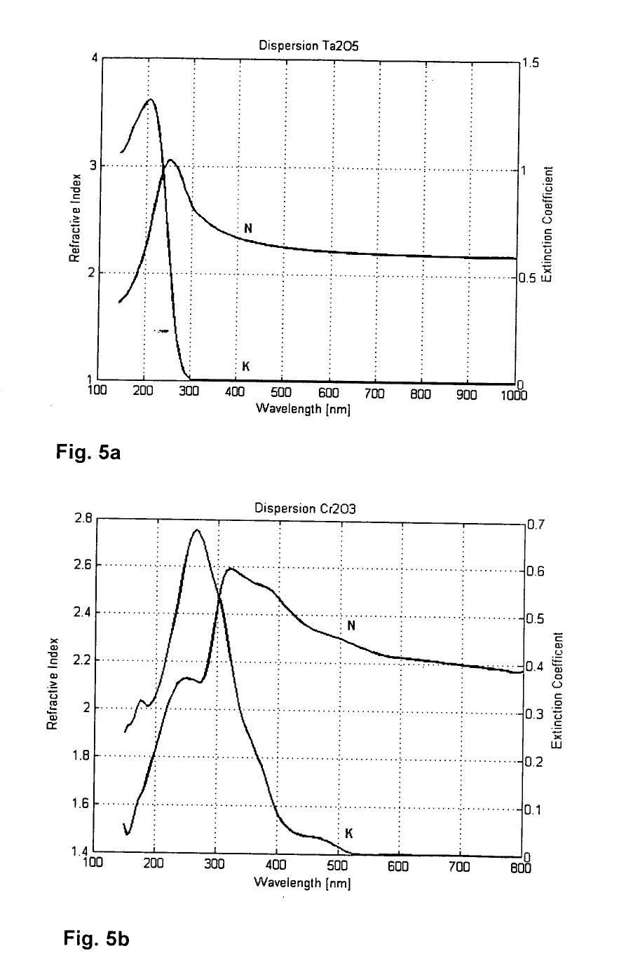

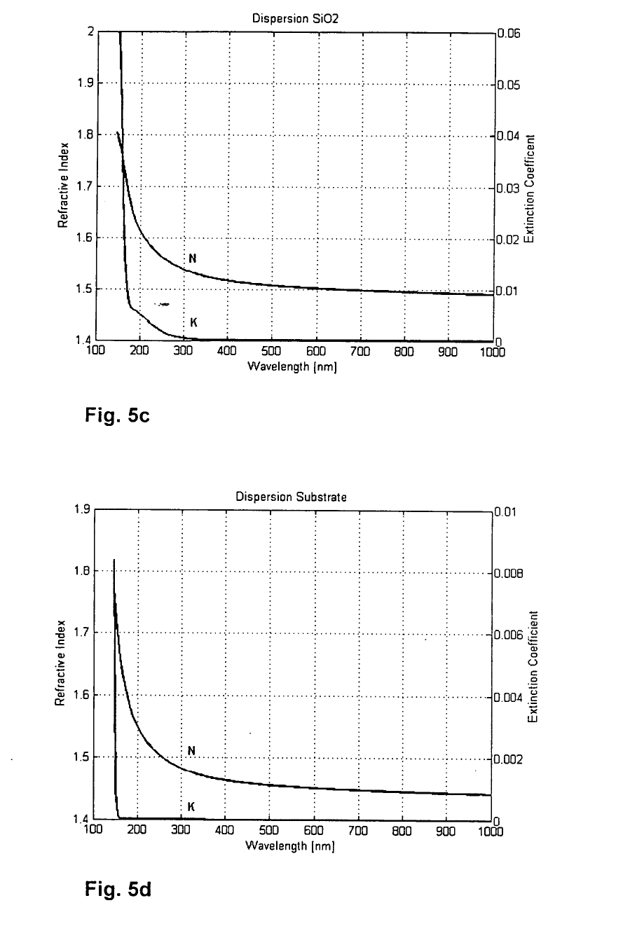

FIGS. 5a, 5b, 5c and 5d show the dispersion curves of Ta₂O₅, Cr₂O₃, SiO₂ and a quartz substrate.

Table 1 lists the dispersion values at the lithography wavelengths 157, 193 and 248 nm of these materials and the SiO₂ substrate.

TABLE 1

| | | |
|---|---|---|
| 157 nm | 193 nm | 248 nm |

| | n | k | n | k | n | k |
|---|---|---|---|---|---|---|
| Substrate | 1.66 | 0 | 1.56 | 0 | 1.5 | 0 |
| Ta₂O₅ | 1.79 | 1.11 | 2.14 | 1.28 | 3.05 | 0.64 |
| Cr₂O₃ | 1.48 | 0.27 | 1.78 | 0.31 | 2.13 | 0.63 |
| Al₂O₃ | | | 1.92 | 0.016 | 1.76 | ≈0 |
| SiO₂ | 1.75 | 0.028 | 1.62 | 0.005 | 1.56 | ≈0 |

The dispersion data of Table 1 above was used to carry out the following calculations. All simulations are based on the widely used matrix algorithm as described in A. Macleod, “Thin-film optical filters”, 2^{nd} edition, 1986, Bristol, Adam Hilger, for thin films using Matlab for numerical computations.

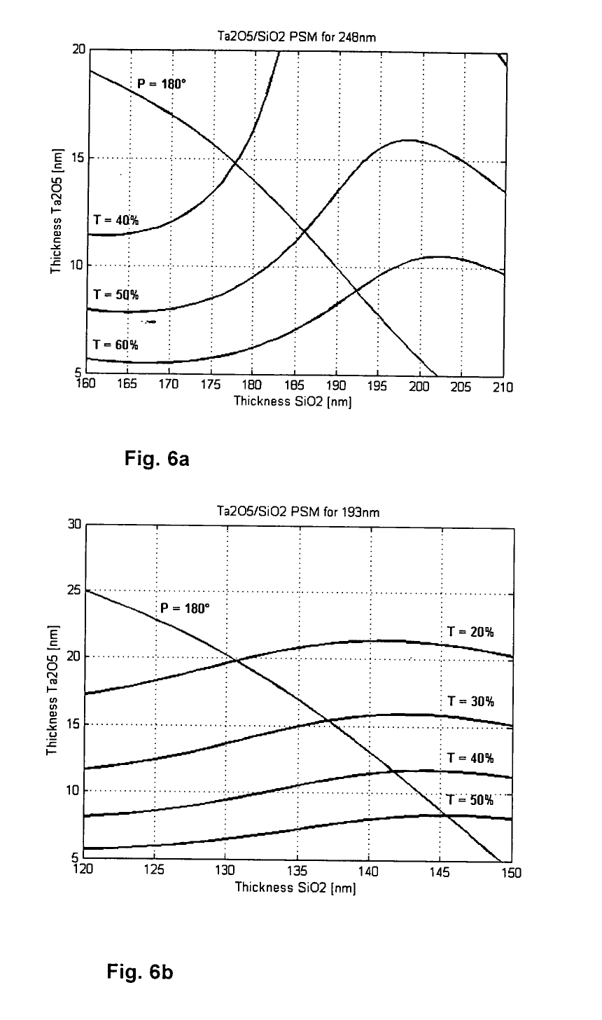

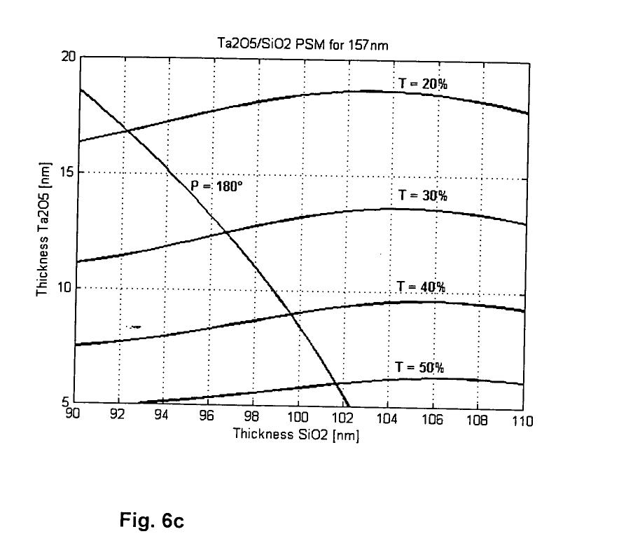

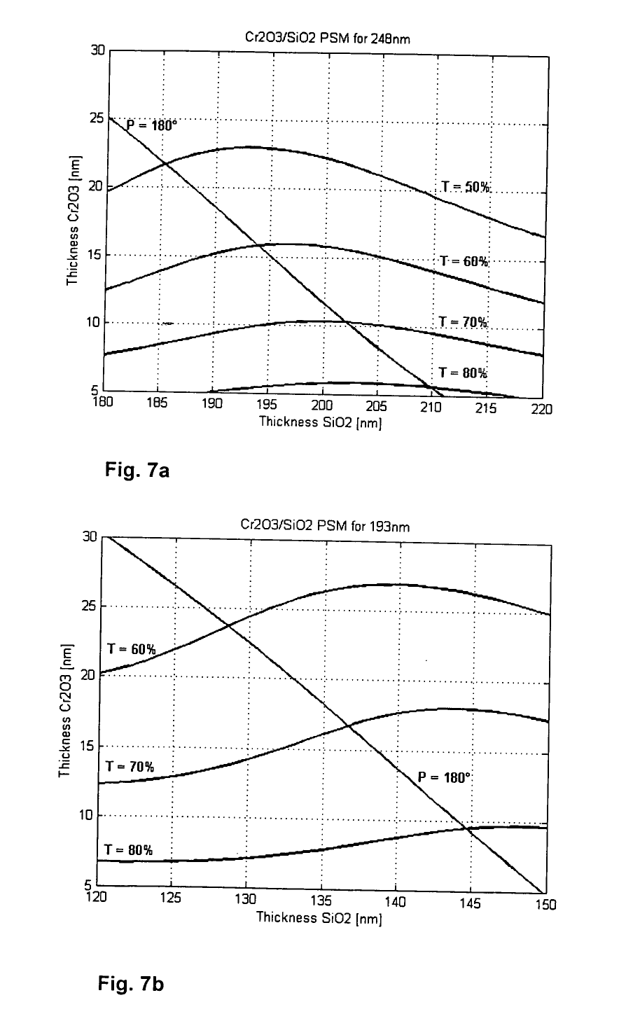

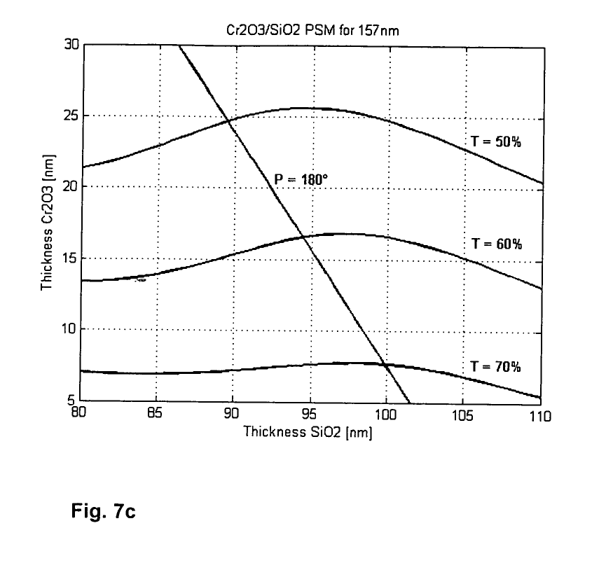

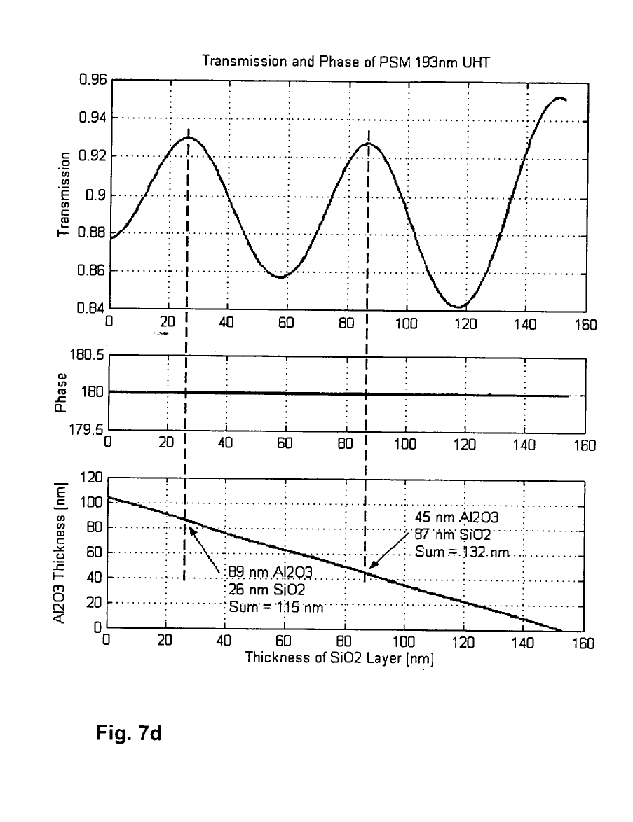

FIGS. 6a, 6b, 6c, 7a, 7b, 7c and 7d illustrate the tuneability of the transmission for the phase shifting systems. On the x-axis the film thickness of SiO₂ is provided and on the y-axis the film thickness of the etch stop layer, i.e. tantalum oxide in FIGS. 6a, 6b and 6c, chromium oxide in FIGS. 7a, 7b and 7c and aluminum oxide in FIG. 7d. The approximately vertical solid line indicates all combinations of film thickness of the SiO₂-layer and the etch stop layer that result in a 180° phase shift. The approximately horizontal graphs correspond to different transmission values corresponding to different sublayer thickness. Line oscillations are caused by interference effects. Such oscillation effects can change the transmission to a substantial amount, however, they do not substantially lower the transmission of the phase shift control sublayer but at most lead to a substantially higher transmission. Since at exposure wavelengths of 300 nm or less, most materials have a very low transmission, an effect such as the described oscillation that may lead to a higher transmission is rather advantageous.

FIGS. 6a, 6b, 6c, 7a, 7b, 7c and 7d the horizontal oscillating lines show possible film thickness combinations of etch stop layer and SiO₂ for different transmissions. The vertical line crossing the horizontal lines are combinations of etch stop layer and SiO₂ yielding a phase shift of 180°. At points designating a certain layer thickness of the etch stop layer and a certain thickness of the SiO₂ layer in that the vertical lines cross the horizontal lines, a phase shift system for a given transmission with a phase shift of 180° can be achieved.

When using tantalum oxide as the etch stop layer and assuming a minimum tantalum oxide layer thickness of 9 nm, transmission can be tuned up to 40% for the 157 nm system (FIG. 6c), 50% for the 193 nm system (FIG. 6b) and 80% for the 248 nm system (FIG. 6a).

When using chromium oxide as the etch stop layer and assuming a minimum chromium oxide layer thickness of 9 nm, transmission can be tuned up to 70% for the 157 nm system (FIG. 7c), 80% for the 193 nm system (FIG. 7b) and 80% for the 248 nm system (FIG. 7a).

When using aluminum oxide as the etch stop layer which also contributes to the phase shift of the phase shift system, transmission can be tuned up to more than 90% for the 193 nm system (FIG. 7d).

In all cases wavelengths high transmission phase shift mask blanks according to the invention can be produced.

Deposition Experiments

(A) Deposition Tool

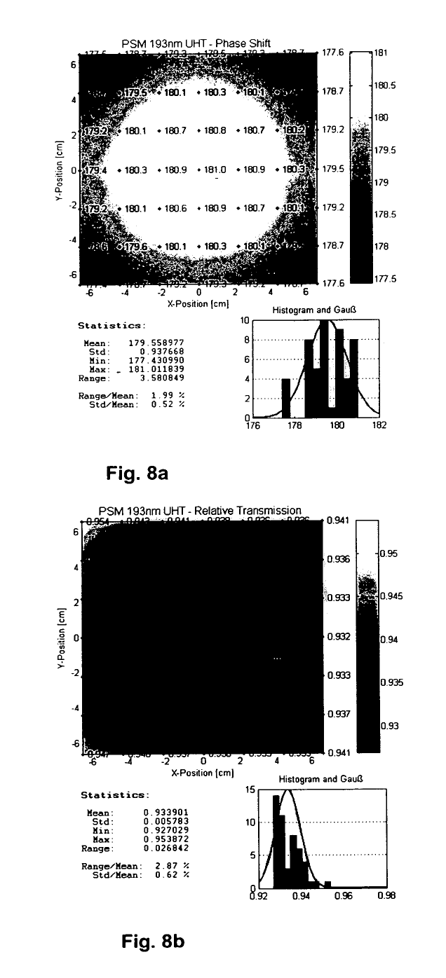

All layers were deposited using a dual ion beam sputtering tool as schematically shown in FIG. 8. In particular, a Veeco Nexus LDD Ion Beam Depostition Tool was used for all depositions.

(B) Deposition Parameters

The exact deposition parameters were determined by DOE using as software JMP, release 5.0. 1a, by SAS Institute Inc., SAS Campus Drive, Cary, North Carolina 27513, USA.

(C) Exemplary Mask Blanks

Mask blanks for an exposure wavelength of 193 nm as shown in Table 2 are manufactured:

TABLE 2a
Exemplary mask blanks for 157, 193 and 248 nm

| | | | | | | |
|---|---|---|---|---|---|---|
| Ex. 1 | Ex. 2 | Ex. 3 | Ex. 4 | Ex. 5 | Ex. 6 | Ex. 7 |

| | | | | | | | |
|---|---|---|---|---|---|---|---|
| Exposure | 157 | 157 | 193 | 193 | 248 | 248 | 248 |
| wavelength | | | | | | | |
| [nm] | | | | | | | |
| Substrate | F/SiO₂ | F/SiO₂ | SiO₂ | SiO₂ | SiO₂ | SiO₂ | SiO₂ |
| Etch stop layer | | | | | | | |
| Material | Ta₂O₅ | Cr₂O₃ | Ta₂O₅ | Cr₂ O₃ | Cr₂ O₃ | Ta₂ O₅ | Cr₂O₃ |
| Layer thickness | 9 | 13 | 9 | 10 | 22 | 9 | 10 |
| [nm] | | | | | | | |
| Phase shift | | | | | | | |
| layer | | | | | | | |
| Material | SiO₂ | SiO₂ | SiO₂ | SiO₂ | SiO₂ | SiO₂ | SiO₂ |
| Layer thickness | 99 | 97 | 145 | 145 | 184 | 193 | 202 |
| [nm] | | | | | | | |
| Total thickness | 108 | 110 | 154 | 155 | 206 | 202 | 212 |
| of phase shift | | | | | | | |
| system [nm] | | | | | | | |
| Light shielding | | | | | | | |
| layer | | | | | | | |
| Material | Cr | Cr | Cr | Cr | Cr | Cr | Cr |
| Phase Shift | 180° | 180° | 180° | 180° | 180° | 180° | 180° |
| Transmission | 40 | 65 | 50 | 80 | 50 | 60 | 70 |
| [%] | | | | | | | |

TABLE 2b
Further exemplary mask blanks

| | Ex. 8 | Ex. 9 | Ex. 10 | Ex. 11 |
|---|---|---|---|---|
| Exposure wavelength | 193 | 193 | 193 | 193 |
| [nm] | | | | |
| Substrate | SiO₂ | SiO₂ | SiO₂ | SiO₂ |
| Etch stop layer | | | | |
| Material | Al₂O₃ | Al₂O₃ | Al₂O₃ | Ta₂O₅ |
| Layer thickness | 89 | 45 | 10 | 1 |
| [nm] | | | | |
| Phase shift | | | | |
| layer | | | | |
| Material | SiO₂ | SiO₂ | SiO₂ | Al₂O₃ |
| Layer thickness | 26 | 87 | 140 | 103 |
| [nm] | | | | |
| Total thickness | 115 | 132 | 150 | 104 |
| of phase shift | | | | |
| system [nm] | | | | |
| Light shielding | | | | |
| layer | | | | |
| Material | Cr | Cr | Cr | Cr |
| Phase Shift | 180° | 180° | 180° | 180° |
| Transmission | 93 | 93 | 93 | 85 |
| [%] | | | | |

All mask blanks show a transmission of more than 40% and a phase shift of approximately 180° at the exposure wavelength.

In etching experiments, the etch stop layer provides sufficient etch stop function when the layer on the etch stop layer is etched. E.g. if the standard light shielding layer of chromium is etched using the standard Cl+O dry etch process, all layers of the Examples under the light shielding layer provide sufficient etch stop function. Furthermore, a sufficient etch stop function is also provided relative to the substrate, i.e. an etch stop layer on the substrate can be etched with an etching agent that essentially does not etch the substrate. E.g. for etching the layers on the substrate, a dry etch process using Cl can be used that substantially does etch the substrate.

Examples 1 to 10 relate to phase shift mask blanks wherein the etch stop layer is provided under the phase shift layer (FIGS. 1a to 1d). Example 11 relates to a phase shift mask blank wherein the etch stop layer is provided on the phase shift layer (FIGS. 1e to 1h).

In Example 11, the Ta₂O₅ etch stop layer on the phase shift layer also provides a barrier function, i.e. protects the phase shift layer from degradation during cleaning procedures. Although this Ta₂O₅ layer has a thickness of only 1 nm, it is not removed when etching a standard light shielding layer of chromium with the standard Cl+O dry etch process.

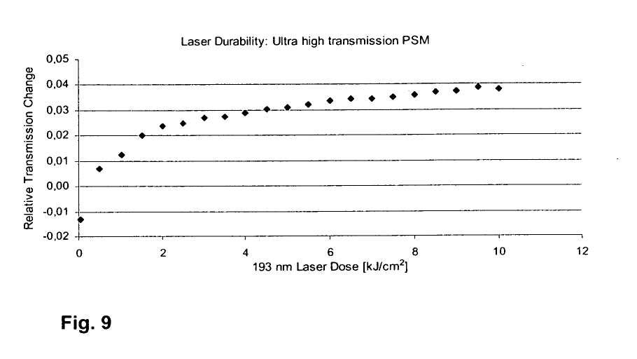

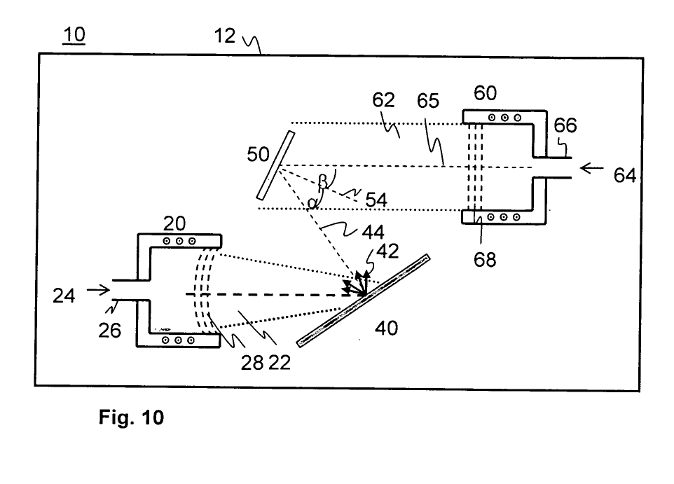

FIGS. 8a and 8b show the optical performance of the mask blank according to Example 8. The measurement as shown in FIG. 9a confirm the phase shift of 180°. The range of the phase shift is below ±2° (FIG. 9a). As shown in FIG. 9b, the transmission exceeds 93% and range of the transmission is below ±1.4. %. Measurement area is 132×132 mm.

FIG. 9 shows a laser durability test of the mask blank according to Example 8. Pulse energy is 2 mJ/cm² and repetition rate is 1 kHz. Up to a cumulative dose of 10 kJ/cm² transmission change is within the within the allowed range of 0.05. Laser stability of the phase shift system is therefore good.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A phase shift mask blank, the mask blank comprising a substrate and a phase shift system
wherein said phase shift system comprises at least two layers;
wherein at least one of the layers of the phase shift system is a phase shift layer and provides a phase shift function and wherein at least one further layer of the phase shift system is an etch stop layer and provides an etch stop function;
said mask blank being able of producing a photomask with substantially 180° phase shift and an optical transmission of at least 40%, at an exposure light having a wavelength of 300 nm or less.

2. The mask blank according to claim 1, wherein said layer providing an etch stop function has a thickness of at least 0.5 nm.

3. The mask blank according to claim 1, wherein said etch stop layer essentially consists of one or more materials having a value for the extinction coefficient k of about 1.5 or less at exposure light wavelength.

4. The mask blank according to claim 1, wherein said phase shift layer essentially consists of one or more materials having a value for the extinction coefficient k of about 0.3 or less at exposure light wavelength.

5. The mask blank according to claim 1, wherein an etch stop layer comprises a material selected from the group consisting of oxides or fluorides of Si, Ge, Sn, B, Al, Ga, Ti, Zr, Hf, V, Nb, Ta, Cr, Mo, W, Y, La, Gd or mixtures thereof.

6. The mask blank according to claim 1, wherein a phase shift layer comprises a material selected from the group consisting of oxides and/or nitrides of Si, Al, B, Ge or mixtures thereof.

7. The mask blank according to claim 1, wherein said phase shift system has a thickness of at most 350 nm.

8. The mask blank according to claim 1, wherein said mask blank further comprises at least one antireflection layer providing an antireflection function, wherein an antireflection layer preferably is provided on, under and/or in the phase shift system.

9. The mask blank according to claim 8, wherein said antireflection layer preferably has a refractive index at exposure wavelength which is lower than the refractive index of the layer on which the antireflection layer is provided.

10. The mask blank according to claim 1, wherein said mask blank further comprises a barrier layer providing a barrier function, wherein said barrier layer is provided on the phase shift system, wherein said barrier layer has a thickness of at most 4 nm.

11. The mask blank according to claim 10, wherein said barrier layer comprises a metal oxide such as an oxide of Ti, Zr, Hf, V, Nb, Ta, Cr, Mo, W, Y, La, Gd or mixtures thereof.

12. The mask blank according to claim 1 wherein the mask blank further comprises a light shielding layer on the phase shift system.

13. A process for the preparation of a phase shift mask, the mask blank comprising a substrate and a phase shift system, wherein said phase shift system comprises at least two layers; wherein at least one of the layers of the phase shift system is a phase shift layer and provides a phase shift function and wherein at least one further layer of the phase shift system is an etch stop layer and provides an etch stop function; said mask blank being able of producing a photomask with substantially 180° phase shift and an optical transmission of at least 40%, at an exposure light having a wavelength of 300 nm or less, comprising the steps
providing a substrate; and
providing a thin film system;
wherein providing a thin film system comprises the steps of
forming at least one etch stop layer on the substrate,
forming at least one phase shift layer on an etch stop layer.

14. The process according to claim 13, wherein for the deposition of the layers a method selected from the group consisting of dual ion beam deposition, ion beam assisted deposition, ion beam sputter deposition, RF matching network, DC magnetron, AC magnetron, and RF diode.

15. A phase shift photomask for lithography, the photomask comprising a substrate and a phase shift system, wherein said phase shift system comprises at least two layers, wherein at least one of the layers of the phase shift system is a phase shift layer and provides a phase shift function and wherein at least one further layer of the phase shift system is an etch stop layer and provides an etch stop function, said photomask having substantially 180° phase shift and an optical transmission of at least 40%, at an exposure light having a wavelength of 300 nm or less.

16. A method of manufacturing a photomask for lithography, the photomask comprising a substrate and a phase shift system, wherein said phase shift system comprises at least two layers, wherein at least one of the layers of the phase shift system is a phase shift layer and provides a phase shift function and wherein at least one further layer of the phase shift system is an etch stop layer and provides an etch stop function, said photomask having substantially 180° phase shift and an optical transmission of at least 40%, at an exposure light having a wavelength of 300 nm or less; comprising the steps of
providing a mask blank comprising a substrate, a phase shift system and a light shielding layer, wherein said phase shift system comprises at least two layers; wherein at least one of the layers of the phase shift system is a phase shift layer and provides a phase shift function and wherein at least one further layer of the phase shift system is an etch stop layer and provides an etch stop function;
etching the light shielding layer using a first etching agent;
etching the layer on the substrate using a second etching agent; wherein said second etching agent substantially does not etch the substrate.
